(19) United States
(12) Patent Application Publication
(10) Pub. No.: US 2006/0135704 A1
(43) Pub. Date: Jun. 22, 2006

(54) Tack free compositions useful for electronic encapsulation

(76) Inventors: Michael Alan Vallance, Loudonville, NY (US); John Robert Campbell, Clifton Park, NY (US); Kenneth Paul Zarnoch, Scotia, NY (US); Prameela Susarla, Clifton Park, NY (US); Bryan Patrick Duffey, Ballston Spa, NY (US); Gary William Yeager, Rexford, NY (US); Michael Joseph O'Brien, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/022,904

(22) Filed: Dec. 22, 2004

(51) Int. Cl. C08F 283/08; C08F 118/02

(52) U.S. Cl. 525/391; 526/319

(57) ABSTRACT

A tack-free composition comprising a functionalized polymer having a having a glass transition temperature greater than about 24° C., a reactive monomer, said reactive monomer having a melting point or softening point greater than about 24° C., a reinforcing filler, and an initiator (curing agent) is provided. The tack-free composition is useful as a molding composition for encapsulation of electronic devices and electronic device components.

### BACKGROUND OF INVENTION

The invention described generally relates to compositions which are useful as molding compositions for encapsulating electronic components, and more particularly, wherein at room temperature, the compositions are solids.

Electronic components, such as integrated circuits, are often encapsulated, typically by transfer molding, for environmental protection and in order to maintain structural and functional integrity. Typically, the encapsulating material is a polymeric composition. Such encapsulating materials are useful for encapsulation of semiconductors, semiconductor integrated circuits, passives, passive networks, multichip modules, opto-electronic devices and numerous other applications.

Currently available encapsulanting materials suffer from a variety of drawbacks, among them their physical state. The resins can be particularly difficult to work with during transfer molding as they are thick liquids or semi-solid putties at room temperature. A solid, tack-free encapsulating material would present significant advantages. For example, to encapsulate electronic devices, desirable molding compositions should be solid at room temperature, should soften between 50° C. and 90° C., and should exhibit a desirable flow (spiral flow length) at low viscosity at 125° C. to 175° C.

Various polymer compositions that are used for encapsulating semiconductor devices are disclosed in U.S. Pat. No. 4,632,798 which describes a molding composition of comprising a melt processable thermotropic liquid crystalline polymer which has a weight average molecular weight of from 4000 to 10000 grams per mole and which is substantially incapable of further chain growth upon heating. Dispersed within the liquid crystalline polymer is 40 to 80 weight % of a particulate inorganic filler material, such as SiO₂. It is common practice to include an inorganic particulate filler material, such as silica or alumina, which serves among other things to increase thermal conductivity and to decrease the linear coefficient of thermal expansion of the molding composition. Also, U.S. Pat. No. 4,632,798 addresses the problems of such fillers greatly modifying (i.e., increasing) the viscosity of the composition during molding, especially when the filler is present in a high concentration. If the viscosity becomes too great, the molding composition becomes difficult to cause to flow and to fill the mold, and then voids can be present in the resultant encapsultant molding. Additionally, U.S. Pat. No. 4,632,798 addresses the problems of resins used as encapsulants needing to be refrigerated prior to use.

U.S. Pat. No. 5,355,016 describes an erasable programmable read only memory chip that has an ultraviolet light transmitting resin transfer molded onto the circuit carrying substrate, covering the chip and its wire bonds. This patent lists suitable encapsulating materials as epoxies, polyesters, polyetherimides, acrylics, allyl diglycol carbonates, cellulose acetate butyrate, phenolics, polyphenylene oxide, polyphenylene sulfide, polyphenyl sulfone, polyaryl sulfones, polyarylates, polycarbonates, and polyvinyl chloride.

U.S. Pat. No. 5,998,876 discloses an encapsulated circuit assembly that includes a chip, a substrate, and a solder joint, where the solder joint spans between the chip and the substrate forming an electrically conductive connection and where an encapsulant is formed adjacent the solder joint. The encapsulant is a polymer selected from poly(aryl ether phenylquinoxalines), poly(etherquinolines), poly(aryl esters), poly(ether ketones), poly(ether sulfones), polyphenylene, polyphenylene oxide, polycarbonates, and poly(etherimides).

U.S. Pat. No. 5,272,377 describes a resin encapsulated semiconductor device, wherein the resin composition is a maleimide resin, a phenolic resin curing agent, an inorganic filler, and a binary curing catalyst of basic catalyst and peroxide catalyst. Novolac-type phenolic resin having two or more phenolic hydroxyl groups in a single molecule is used.

International Publication No. WO 03/072628 A1 published Sep. 4, 2003 discloses an epoxy resin composition for encapsulating electronic parts, where the composition includes novolac type phenolic resins.

Despite the technical efforts suggested by the references cited there remains a need for encapsulating materials possessing improved performance.

### SUMMARY OF INVENTION

In one aspect, the present invention provides a composition comprising:

(a) at least one functionalized polymer having a glass transition temperature greater than about 24° C.;

(b) at least one reactive monomer, said reactive monomer having a melting point or softening point greater than about 24° C.;

(c) at least one reinforcing filler; and

(d) at least one initiator; wherein said composition is a tack-free at room temperature.

In another embodiment, the present invention provides a cured composition comprising structural units derived from:

(a) at least one functionalized polymer having a glass transition temperature greater than about 24° C.;

(b) at least one reactive monomer, said reactive monomer having a melting point or softening point greater than about 24° C.;

(c) at least one reinforcing filler; and

(d) at least one initiator;

said composition being tack-free at room temperature prior to being cured.

In another aspect, the present invention provides an electronic circuit comprising at least one active or passive component, said electronic circuit being encapsulated encapsulant derived from a tack-free composition of the present invention.

### BRIEF DESCRIPTION OF DRAWINGS

FIG. 1 is a perspective, cut-away view of an electronic assembly in accordance with the present invention.

FIG. 2 is a cross-sectional view of the electronic assembly, where the view is taken through section 2-2 of FIG. 1.

### DETAILED DESCRIPTION

Although it is not intended to be limited to any particular embodiment, the invention is now described below with reference to the accompanying description, Figures, Examples and Comparative Examples.

Various abbreviations, as employed here, are summarized in below and have the meanings indicated.

ABBREVIATIONS

| | |
|---|---|
| ADEP | aluminum diethylphosphinate |
| BPA | bisphenol A dimethacrylate |
| BVM | bis[[4- |
| | [(vinyloxy)methyl]cyclohexyl]methyl]terephthalate |
| CPAE | capped poly(arylene ether) |
| C | Centigrade |
| Cm | Centimeter |
| CDD | cyclohexane dimethanol diacrylate |
| EMI | electro-magnetic interference |
| EMMI | Epoxy Molding Materials Institute |
| E2BPA | ethoxylated(2) bisphenol A dimethacrylate |
| 4-BiPh | 4-biphenyl methacrylate |
| IV | intrinsic viscosity |
| Mpa | mega Pascal |
| MPP | melamine polyphosphate |
| MACP | methacrylate capped poly(2,6-dimethyl phenylene |
| DMPE | ether) |
| Mm | Millimeter |
| No. | Number |
| 1,6- | 1,6-hexanediol diacrylate |
| HDD | |
| 1,5- | 1,5-dimethacryloyl naphthalene |
| NP | |
| Ppm | parts per million |
| PPE | polyphenylene ether |
| RFI | radio frequency interference |
| Rpm | Rotations per minute |
| SEMI | Semiconductor Equipment and Materials Institute |
| SMA | styrene maleic anhydride |
| TBC | t-butyl catechol |
| TBPB | t-butyl peroxybenzoate |
| TMBPA | tetramethyl bisphenol A dimethacrylate |
| TMBiPh | tetramethyl biphenol dimethacrylate |

As noted, in a first aspect the present invention provides a tack-free composition comprising at least one functionalized polymer having a glass transition temperature greater than about 24° C., said compositions further comprising at least one reactive monomer, said reactive monomer having a melting point or softening point greater than about 24° C., at least one reinforcing filler, and at least one initiator.

The functionalized polymer may be any polymer having a glass transition temperature (Tg) greater than about 24° C. comprising functional groups capable of reacting with the reactive monomer. Examples of functionalized polymers suitable for inclusion in the compositions of the present invention include functionalized polycarbonates, functionalized polyesters, functionalized olefin polymers, and functionalized poly(arylene ethers). Functionalized polycarbonates are illustrated by bisphenol A polycarbonate which incorporates at least one methacryloyloxy group, for example hydroxyl-terminated bisphenol A polycarbonate which has been further reacted with methacryloyl chloride. Similarly, functionalized polyesters are illustrated by poly(ethylene terephthalate) comprising terminal acryloyloxy groups. Those skilled in the art will appreciate that such functionalized polyesters are readily prepared from the corresponding hydroxyl-terminated polyesters. Functionalized olefin polymers are illustrated by polystyrene comprising at least one methacryloyloxy group. Those skilled in the art will appreciate that such functionalized olefin polymers are readily prepared from the corresponding hydroxyl-terminated olefin polymers.

The functionalized polymer may be comprise functional groups capable of reacting with the reactive monomer. Typically, the functional groups of the functionalized polymer are selected from the group consisting of alkeneyl groups, allyl groups, vinyl groups, acrylate groups, methacrylate groups, vinyl ether groups, vinyl ketone groups, and cinnamyl groups. Frequently, the groups methacryloyloxy and acryloyloxy are preferred.

In one aspect, the functionalized polymer is a functionalized poly(arylene ether). The functionalized poly(arylene ether) may be a “capped” poly(arylene ether) (abbreviated herein as CPAE), a ring-functionalized poly(arylene ether), or an acid- or anhydride-functionalized poly(arylene ether), or any combination of these poly(arylene ethers).

A capped poly(arylene ether) is defined herein as a poly(arylene ether) in which at least 50%, preferably at least 75%, more preferably at least 90%, yet more preferably at least 95%, even more preferably at least 99%, of the free hydroxyl groups present in the corresponding uncapped poly(arylene ether) have been functionalized by reaction with a capping agent. The capped poly(arylene ether) may be represented by the structure
Q(J-K)_{y}
wherein Q is the residuum of a monohydric, dihydric, or polyhydric phenol, preferably the residuum of a monohydric or dihydric phenol, more preferably the residuum of a monohydric phenol; y is 1 to 100; J comprises repeating structural units having the formula 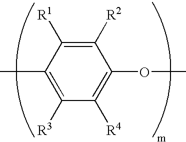
wherein m is 1 to about 200, preferably 2 to about 200, and R¹ and R³ are each independently hydrogen, halogen, primary or secondary C₁-C₁₂ alkyl, C₂-C₁₂ alkenyl, C₂-C₁₂ alkynyl, C₁-C₁₂ aminoalkyl, C₁-C₁₂ hydroxyalkyl, phenyl, C₁-C₁₂ haloalkyl, C₁-C₁₂ hydrocarbyloxy, C₂-C₁₂ halohydrocarbyloxy wherein at least two carbon atoms separate the halogen and oxygen atoms, or the like; R² and R⁴ are each independently halogen, primary or secondary C₁-C₁₂ alkyl, C₂-C₁₂ alkenyl, C₂-C₁₂ alkynyl, C₁-C₁₂ aminoalkyl, C₁-C₁₂ hydroxyalkyl, phenyl, C₁-C₁₂ haloalkyl, C₁-C₁₂ hydrocarbyloxy, C₂-C₁₂ halohydrocarbyloxy wherein at least two carbon atoms separate the halogen and oxygen atoms, or the like; and K is a capping group produced by reaction of a phenolic hydroxyl group on the poly(arylene ether) with a capping agent. The resulting capping group, K, may be 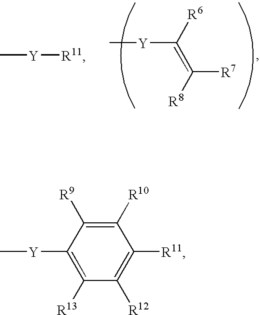
or the like, wherein R⁵ is C₁-C₁₂ hydrocarbyl optionally substituted with one or two carboxylic acid groups, or the like; R⁶—R⁸ are each independently hydrogen, C₁-C₁₈ hydrocarbyl optionally substituted with one or two carboxylic acid groups, C₂-C₁₈ hydrocarbyloxycarbonyl, nitrile, formyl, carboxylic acid, imidate, thiocarboxylic acid, or the like; R⁹—R¹³ are each independently hydrogen, halogen, C₁-C₁₂ alkyl, hydroxy, amino, carboxylic acid, or the like; and wherein Y is a divalent group such as 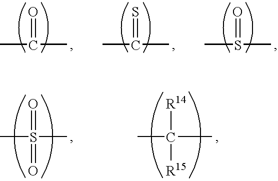
or the like, wherein R¹⁴ and R¹⁵ are each independently hydrogen, C₁-C₁₂ alkyl, or the like.

As used herein, “hydrocarbyl” refers to a residue that contains only carbon and hydrogen. The residue may be aliphatic or aromatic, straight-chain, cyclic, bicyclic, branched, saturated, or unsaturated. The hydrocarbyl residue, when so stated however, may contain heteroatoms over and above the carbon and hydrogen members of the substituent residue. Thus, when specifically noted as containing such heteroatoms, the hydrocarbyl residue may also contain carbonyl groups, amino groups, hydroxyl groups, carboxylic acid groups, halogen atoms, or the like, or it may contain heteroatoms within the backbone of the hydrocarbyl residue.

In one embodiment, Q is the residuum of a phenol, including polyfunctional phenols, and includes radicals of the structure 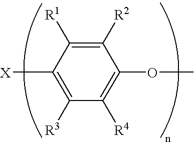
wherein R¹ and R³ are each independently hydrogen, halogen, primary or secondary C₁-C₁₂ alkyl, C₂-C₁₂ alkenyl, C₂-C₁₂ alkynyl, C₁-C₁₂ aminoalkyl, C₁-C₁₂ hydroxyalkyl, phenyl, C₁-C₁₂ haloalkyl, C₁-C₁₂ hydrocarbyloxy, C₂-C₁₂ halohydrocarbyloxy wherein at least two carbon atoms separate the halogen and oxygen atoms, or the like; R² and R⁴ are each independently halogen, primary or secondary C₁-C₁₂ alkyl, C₂-C₁₂ alkenyl, C₂-C₁₂ alkynyl, C₁-C₁₂ aminoalkyl, C₁-C₁₂ hydroxyalkyl, phenyl, C₁-C₁₂ haloalkyl, C₁-C₁₂ hydrocarbyloxy, C₂-C₁₂ halohydrocarbyloxy wherein at least two carbon atoms separate the halogen and oxygen atoms, or the like; X may be hydrogen, C₁-C₁₈ hydrocarbyl, or C₁-C₁₈ hydrocarbyl containing a substituent such as carboxylic acid, aldehyde, alcohol, amino radicals, or the like; X also may be sulfur, sulfonyl, sulfuryl, oxygen, or other such bridging group having a valence of 2 or greater to result in various bis- or higher polyphenols; n (i.e., the number of phenylene ether units bound to X) is 1 to about 100, preferably 1 to 3, and more preferably 1 to 2. Q may be the residuum of a monohydric phenol, such as 2,6-dimethylphenol, in which case n is 1. Q may also be the residuum of a diphenol, such as 2,2′,6,6′-tetramethyl-4,4′-diphenol, in which case n is 2.

In one embodiment, the uncapped poly(arylene ether) may be defined by reference to the capped poly(arylene ether) Q(J-K), as Q(J-H), where Q, J and y are defined above, and a hydrogen atom, H, has taken the place of any capping group, K. In one embodiment, the uncapped poly(arylene ether) consists essentially of the polymerization product of at least one monohydric phenol having the structure 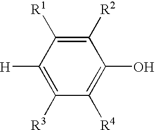
wherein R¹ and R³ are each independently hydrogen, halogen, primary or secondary C₁-C₁₂ alkyl, C₂-C₁₂ alkenyl, C₂-C₁₂ alkynyl, C₁-C₁₂ aminoalkyl, C₁-C₁₂ hydroxyalkyl, phenyl, C₁-C₁₂ haloalkyl, C₁-C₁₂ hydrocarbyloxy, C₂-C₁₂ halohydrocarbyloxy wherein at least two carbon atoms separate the halogen and oxygen atoms, or the like; and R² and R⁴ are each independently halogen, primary or secondary C₁-C₁₂ alkyl, C₂-C₁₂ alkenyl, C₂-C₁₂ alkynyl, C₁-C₁₂ aminoalkyl, C₁-C₁₂ hydroxyalkyl, phenyl, C₁-C₁₂ haloalkyl, C₁-C₁₂ hydrocarbyloxy, C₂-C₁₂ halohydrocarbyloxy wherein at least two carbon atoms separate the halogen and oxygen atoms, or the like. Suitable monohydric phenols include those described, for example, in U.S. Pat. No. 3,306,875 to Hay, and highly preferred monohydric phenols include 2,6-dimethylphenol and 2,3,6-trimethylphenol. The poly(arylene ether) may be a copolymer of at least two monohydric phenols, such as 2,6-dimethylphenol and 2,3,6-trimethylphenol. Thus the uncapped poly(arylene ether) may comprise poly(2,6-dimethyl-1,4-phenylene ether), poly(2,6-dimethyl-1,4-phenylene ether-co-2,3,6-trimethyl-1,4-phenylene ether) or a mixture thereof. In yet another embodiment, the uncapped poly(arylene ether) is isolated by precipitation and preferably has less than about 400 parts per million of organic impurities and more preferably less than about 300 parts per million. Organic impurities include, for example, 2,3-dihydrobenzofuran, 2,4,6-trimethylanisole, 2,6-dimethylcyclohexanone, 7-methyl-2,3-dihydrobenzofuran, and the like.

In one embodiment, the capped poly(arylene ether) comprises at least one capping group having the structure 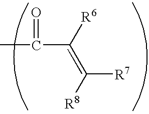
wherein R⁶—R⁸ are each independently hydrogen, C₁-C₁₈ hydrocarbyl optionally substituted with one or two carboxylic acid groups, C₂-C₁₈ hydrocarbyloxycarbonyl, nitrile, formyl, carboxylic acid, imidate, thiocarboxylic acid, or the like. Highly preferred capping groups include acrylate (R⁶═R⁷═R⁸=hydrogen) and methacrylate (R⁶=methyl, R⁷═R⁸=hydrogen). It will be understood that the term “(meth)acrylate” means either acrylate or methacrylate.

In another embodiment, the capped poly(arylene ether) comprises at least one capping group having the structure 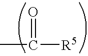
wherein R⁵ is C₁-C₁₂ hydrocarbyl optionally substituted with one or two carboxylic acid groups, preferably C₁-C₆ alkyl, more preferably methyl, ethyl, or isopropyl. The advantageous properties of the invention can be achieved even when the capped poly(arylene ether) lacks a polymerizable function such as a carbon-carbon double bond.

In yet another embodiment, the capped poly(arylene ether) comprises at least one capping group having the structure 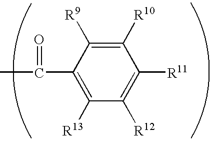
wherein R⁹—R¹³ are each independently hydrogen, halogen, C₁-C₁₂ alkyl, hydroxy, amino, carboxylic acid, or the like. Preferred capping groups of this type include salicylate (R⁹=hydroxy, R¹⁰—R¹³=hydrogen).

In still another embodiment, the capped poly(arylene ether) comprises at least one capping group having the structure 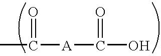
wherein A is a saturated or unsaturated C₂-C₁₂ divalent hydrocarbon group such as, for example, ethylene, 1,2-propylene, 1,3-propylene, 2-methyl-1,3-propylene, 2,2-dimethyl-1,3-propylene, 1,2-butylene, 1,3-butylene, 1,4-butylene, 2-methyl-1,4-butylene, 2,2-dimethyl-1,4-butylene, 2,3-dimethyl- 1,4-butylene, vinylene (—CH═CH—), 1,2-phenylene, and the like. These capped poly(arylene ether) resins may conveniently be prepared, for example, by reaction of an uncapped poly(arylene ether) with a cyclic anhydride capping agent. Such cyclic anhydride capping agents include, for example, maleic anhydride, succinic anhydride, glutaric anhydride, adipic anhydride, phthalic anhydride, and the like.

There is no particular limitation on the method by which the capped poly(arylene ether) is prepared. The capped poly(arylene ether) may be formed by the reaction of an uncapped poly(arylene ether) with a capping agent. Capping agents include compounds known in the literature to react with phenolic groups. Such compounds include both monomers and polymers containing, for example, anhydride, acid chloride, epoxy, carbonate, ester, isocyanate, cyanate ester, or alkyl halide radicals. Phosphorus and sulfur based capping agents also are included. Examples of capping agents include, for example, acetic anhydride, succinic anhydride, maleic anhydride, salicylic anhydride, polyesters comprising salicylate units, homopolyesters of salicylic acid, acrylic anhydride, methacrylic anhydride, glycidyl acrylate, glycidyl methacrylate, acetyl chloride, benzoyl chloride, diphenyl carbonates such as di(4-nitrophenyl)carbonate, acryloyl esters, methacryloyl esters, acetyl esters, phenylisocyanate, 3-isopropenyl-α,α-dimethylphenylisocyanate, cyanatobenzene, 2,2-bis(4-cyanatophenyl)propane, 3-(α-chloromethyl)styrene, 4-(α-chloromethyl)styrene, allyl bromide, and the like, and substituted derivatives thereof, and mixtures thereof. These and other methods of forming capped poly(arylene ether)s are described, for example, in U.S. Pat. No. 3,375,228 to Holoch et al.; U.S. Pat. No. 4,148,843 to Goossens; U.S. Pat. Nos. 4,562,243, 4,663,402, 4,665,137, and 5,091,480 to Percec et al.; U.S. Pat. Nos. 5,071,922, 5,079,268, 5,304,600, and 5,310,820 to Nelissen et al.; U.S. Pat. No. 5,338,796 to Vianello et al.; U.S. Patent Application Publication No. 2001/0053820 A1 to Yeager et al.; and European Patent No. 261,574 B1 to Peters et al.

A capping catalyst may be employed in the reaction of an uncapped poly(arylene ether) with an anhydride. Examples of such compounds include those known to the art that are capable of catalyzing condensation of phenols with the capping agents described above. Useful materials include, but are not limited to, basic compounds including, for example, basic compound hydroxide salts such as sodium hydroxide, potassium hydroxide, tetraalkylammonium hydroxides, and the like; tertiary alkylamines such as tributylamine, triethylamine, dimethylbenzylamine, dimethylbutylamine and the like; tertiary mixed alkyl-arylamines and substituted derivatives thereof such as N,N-dimethylaniline; heterocyclic amines such as imidazoles, pyridines, and substituted derivatives thereof such as 2-methylimidazole, 2-vinylimidazole, 4-dimethylaminopyridine, 4-(1-pyrrolino)pyridine, 4-(1-piperidino)pyridine, 2-vinylpyridine, 3-vinylpyridine, 4-vinylpyridine, and the like. Also useful are organometallic salts such as, for example, tin and zinc salts known to catalyze the condensation of, for example, isocyanates or cyanate esters with phenols. The organometallic salts useful in this regard are known to the art in numerous publications and patents well known to those skilled in this art.

The functionalized poly(arylene ether), may, in one embodiment, be a ring-functionalized poly(arylene ether). In one embodiment, the ring-functionalized poly(arylene ether) is a poly(arylene ether) comprising repeating structural units of the formula 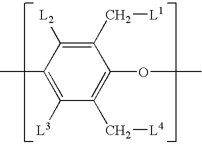
wherein each L¹ -L⁴ is independently hydrogen, a C₁-C₁₂ alkyl group, an alkenyl group, or an alkynyl group; wherein the alkenyl group is represented by 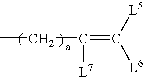
wherein L⁵-L⁷ are independently hydrogen or methyl, and a is 0, 1, 2, 3, or 4; wherein the alkynyl group is represented by 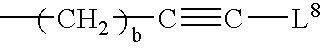
wherein L⁸ is hydrogen, methyl, or ethyl, and b is 0, 1, 2, 3, or 4; and wherein about 0.02 mole percent to about 25 mole percent of the total L¹-L⁴ substituents in the ring-functionalized poly(arylene ether) are alkenyl and/or alkynyl groups. Within this range, it may be preferred to have at least about 0.1 mole percent, more preferably at least about 0.5 mole percent, alkenyl and/or alkynyl groups. Also within this range, it may be preferred to have up to about 15 mole percent, more preferably up to about 10 mole percent, alkenyl and/or alkynyl groups.

The ring-functionalized poly(arylene ether) may be prepared according to known methods. For example, an unfunctionalized poly(arylene ether) such as poly(2,6-dimethyl-1,4-phenylene ether) may be metallized with a reagent such as n-butyl lithium and subsequently reacted with an alkenyl halide such as allyl bromide and/or an alkynyl halide such as propargyl bromide. This and other methods for preparation of ring-functionalized poly(arylene ether) resins are described, for example, in U.S. Pat. No. 4,923,932 to Katayose et al.

In another embodiment, the functionalized poly(arylene ether) is the product of the melt reaction of a poly(arylene ether) and an α,β-unsaturated carbonyl compound or a β-hydroxy carbonyl compound to produce an acid- or anhydride-functionalized poly(arylene ether). In some embodiments both acid and anhydride functionality may be present. Examples of α,β-unsaturated carbonyl compounds include, for example, fumaric acid, maleic acid, maleic anhydride, itaconic acid, itaconic anhydride, citraconic acid, citraconic anhydride, as well as various derivatives of the foregoing and similar compounds. Examples of β-hydroxy carbonyl compounds include, for example, citric acid, malic acid, and the like. Such functionalization is typically carried out by melt mixing the poly(arylene ether) with the desired carbonyl compound at a temperature of about 190 to about 290° C.

There is no particular limitation on the molecular weight or intrinsic viscosity of the functionalized poly(arylene ether). In one embodiment, the composition may comprise a functionalized poly(arylene ether) having a number average molecular weight of about 1,000 to about 25,000 atomic mass units (AMU). Within this range, it may be preferable to use a functionalized poly(arylene ether) having a number average molecular weight of at least about 2,000 AMU, more preferably at least about 4,000 AMU. In another embodiment, the composition may comprise a functionalized poly(arylene ether) having an intrinsic viscosity of about 0.05 to about 0.6 deciliters per gram (dUg) as measured in chloroform at 25° C. Within this range, the functionalized poly(arylene ether) intrinsic viscosity may preferably be at least about 0.08 dL/g, more preferably at least about 0.1 dL/g. Also within this range, the functionalized poly(arylene ether) intrinsic viscosity may preferably be up to about 0.5 dL/g, still more preferably up to about 0.4 dL/g. In one embodiment, the functionalized poly(arylene ether) has an intrinsic viscosity of less than or equal to 0.3 g/dl as measured in chloroform at 25° C. In another embodiment, the functionalized poly(arylene ether) has an intrinsic viscosity of less than or equal to 0.25 g/dl as measured in chloroform at 25° C. In another embodiment, the functionalized poly(arylene ether) has an intrinsic viscosity of less than or equal to 0.15 g/dl as measured in chloroform at 25° C. In another embodiment, the functionalized poly(arylene ether) has an intrinsic viscosity of less than or equal to 0.12 g/dl as measured in chloroform at 25° C. Generally, the intrinsic viscosity of a functionalized poly(arylene ether) will vary insignificantly from the intrinsic viscosity of the corresponding unfunctionalized poly(arylene ether). Specifically, the intrinsic viscosity of a functionalized poly(arylene ether) will generally be within 10% of that of the unfunctionalized poly(arylene ether). It is expressly contemplated to employ blends of at least two functionalized poly(arylene ether)s having different molecular weights and intrinsic viscosities. The composition may comprise a blend of at least two functionalized poly(arylene ethers). Such blends may be prepared from individually prepared and isolated functionalized poly(arylene ethers). Alternatively, such blends may be prepared by reacting a single poly(arylene ether) with at least two functionalizing agents. For example, a poly(arylene ether) may be reacted with two capping agents, or a poly(arylene ether) may be metallized and reacted with two unsaturated alkylating agents. In another alternative, a mixture of at least two poly(arylene ether) resins having different monomer compositions and/or molecular weights may be reacted with a single functionalizing agent. The composition may, optionally, comprise a blend of a functionalized poly(arylene ether) resin and an unfunctionalized poly(arylene ether) resin, and these two components may, optionally, have different intrinsic viscosities. In one embodiment, the functionalized poly(arylene ether) comprises poly phenylene ether (PPO).

The tack-free composition typically comprises from about 5 to about 90 parts by weight of the functionalized poly(arylene ether) per 100 parts by weight total of the functionalized poly(arylene ether) and the reactive monomer. Within this range, the amount of the functionalized poly(arylene ether) resin may preferably be at least about 10 parts by weight, more preferably at least about 15 parts by weight. Also within this range, the amount of the functionalized poly(arylene ether) resin may preferably be up to about 80 parts by weight, more preferably up to about 60 parts by weight, still more preferably up to about 50 parts by weight.

In a preferred embodiment of the invention the functionalized polymer is a capped poly(arylene ether) (CPAE) which is methacrylate-capped poly(2,6-dimethyl phenylene ether) (abbreviated herein as MACPDMPE).

In various embodiments of the present invention the MACPDMPE has an intrinsic viscosity (IV) in a range between about 0.12 and about 0.30, alternately between about 0.2, and about 0.25. In certain embodiments a mixture of functionalized polymers having different intrinsic viscosities is employed. For example, the composition of the present invention may comprise a mixture of MACPDMPE's. In one embodiment this mixture comprises a MACPDMPE having an IV of about 0.12, and a MACPDMPE having an IV of about 0.30, wherein about 50% by weight of the functionalized polymer is the MACPDMPE with an IV of 0.12 and about 50% by weight of the functionalized polymer is the MACPDMPE with an IV of about 0.30. Although not wishing to be limited by any theory, it is believed that a relatively lower IV, such as an IV of about 0.12, is advantageous due to the higher flow properties of the lower IV materals during transfer molding of the composition. It should be noted that a relatively higher IV material, such as a MACPDMPE having an IV of about 0.30, is advantageous in that the resultant compositions will tend to be tack-free at temperatures higher than 24° C.

In one aspect the functionalized polymer having a glass transition temperature greater than about 24° C. useful in the present invention can be produced by capping the hydroxyl radicals of novolac resins with (meth)acrylates. In practice it may be preferred to cap a portion of the hydroxyl groups with (meth)acrylates, while capping the remaining hydroxyl groups with alkyl groups or other radicals which will not participate in polymerization. Novolacs are made by condensation of phenols (such as phenol, cresol, resorcin, catechol, bisphenol A, bisphenol F, phenylphenol, or dihydroxynaphthalene) with an aldehyde (such as formaldehdye, benzaldehyde, or salicylaldehyde) in the presence of an acid catalyst. Novolacs that are made by condensation of phenols and formalin (aqueous formaldehyde) are sold under the trademark SHONOL® by Showa. Suitable novolacs preferably are those that have two or more phenolic hydroxyl groups, and include, but are not limited to, phenolic novolac, cresol novolac (such as methacrylated O-cresol novolac), t-butyl phenolic novolac, nonyl phenolic novolac, aralkyl type of phenol novolac {such as phenol aralkyl novolac or napthol aralkyl novolac synthesized from phenols and/or napthols and for instance, dimethoxyparaxylene or bis (methoxymethol)biphenyl}, dicyclopentadiene phenolic novolac, or combinations thereof.

Suitable solid reactive monomers have melting points or softening points above 24° C. and include, but are not limited to, compounds chosen from allyl esters, allyl cyanurates, allyl isocyanurates, vinyl benzenes, vinyl ethers, vinyl esters, acrylates, methacrylates, or combinations thereof. In one embodiment, the reactive monomer is crystalline and exhibits a melting point in a range between 24° C. and 175° C. In another embodiment the reactive monomer is crystalline and exhibits a melting point in a range between 40° C. and 150° C. In another the reactive monomer is crystalline and exhibits a melting point in a range between 55° C. and 125° C. In yet another the reactive monomer is non-crystalline and exhibits a softening temperature (softening point) in a range between 24° C. and 175° C. In one such embodiment the reactive monomer is non-crystalline and exhibits a softening temperature (softening point) in a range between 40° C. and 150° C. In yet another such embodiment the reactive monomer is non-crystalline and exhibits a softening temperature (softening point) in a range between 55° C. and 125° C.

Suitable vinyl ethers include, but are not limited to, bis[[4-[(vinyloxy)methyl]cyclohexyl]methyl]terephthalate, which is sold by Morflex Inc. under the name VECTOMER® 4051, a trademark registered to Allied Signal Inc. for vinyl ether compositions.

Suitable allylics include, but are not limited to, triallyloxytriazine.

In certain embodiments, suitable reactive monomers are acrylates and/or methacrylates, including, but not limited to, cyclohexane dimethanol diacrylate (melting temperature of about 77 to about 78° C., sold by Sartomer Technology Company, Inc. Wilmington, Del., United States of America, under the trademark SARTOMER® CD 406), 4-biphenyl methacrylate (also known as 4-methacryloyloxy biphenyl, melting temperature of about 105 to 108° C.), bisphenol A dimethacrylate (melting temperature of about 65 to 71° C.), trimethacrylate of tris (4-hydroxyphenyl)ethane, tetramethyl bisphenol A dimethacrylate (melting temperature of about 126 to about 135° C.), biphenol dimethacrylate (melting temperature of about 145 to about 148° C.), tetramethyl biphenol dimethacrylate (melting temperature of about 160 to about 170° C.), sulfonyldiphenol dimethacrylate (melting temperature of about 147 to about 151° C.), 1,5-dimethacryloyl naphthalene (melting temperature of about 97 to about 100 ° C.), or combinations thereof. It is noted that such a reactive monomers with an acrylate and/or a methacrylate functionality could further react, during heating, with itself and/or with the functionalized polymer, for example the capped poly(arylene ether). Thus, such reactive monomers are typically supplied with an inhibitor, such as hydroquinone, to provide stability to the reactive monomer until it is subjected to heating in the presence of an initiator.

In one embodiment, the tack-free composition of the present invention comprises a minor amount, typically about 0.01 to about 0.3 weight %, more particularly about 0.05 to about 0.2 weight %, of a polymerization inhibitor. The compositions of the present invention may comprise one or more polymerization inhibitors which are originally present in the reactive monomer as supplied by a commercial vendor. Alternately, it may be advantageous to add polymerization inhibitors in addition to any polymerization inhibitor which may be present in the reactive monomer. A wide variety of polymerization inhibitors are known to those skilled in the art. These include phenolics, for example catechol, and C₁ to C₄ alkyl catechols such as methyl catechol, ethyl catechol, propyl catechol, isopropyl catechol, butyl catechol, t-butyl catechol. In some instances, mixtures of C₁ to C₄ alkyl catechols may be employed. Particularly suitable is t-butyl catechol (sold by Aldrich) Other suitable polymerization inhibitors include hindered amines and the like.

In one embodiment, a mixture of a CPAE, a reactive monomer, an initiator, and a polymerization inhibitor is heated to form a molten liquid and then cooled and crystallized to provide a friable composition which may be compounded with a filler to provide the compositions of the present invention.

Typically, the compositions of the present invention comprise at least one functionalized polymer having a glass transition temperature greater than about 24° C., a reactive monomer having a melting point or softening point greater than about 24° C., at least one initiator (also referred to as a “curing agent”), at least one reinforcing filler, and optionally a polymerization inhibitor, and optionally a mold release agent, and optionally a colorant, and optionally a flame retardant, and optionally an adhesion promoter. In one embodiment the functionalized polymer, the reactive monomer, and the polymerization inhibitor are mixed with heating to form a molten liquid, to which may be added the reinforcing filler and any of the optional ingredients in any order to provide the compositions of the present invention.

In one embodiment, based on the combined weight of the functionalized polymer, the reactive monomer, and the polymerization inhibitor, the composition of the present invention comprises from about 5 to about 45 weight %, more particularly 10 to about 30 weight %, of a capped poly(arylene ether), about 55 to about 95% weight %, more particularly about 70 to about 90 weight %, of a reactive monomer, and a minor amount, typically about 0.01 to about 0.3 weight %, more particularly about 0.05 to about 0.2 weight %, of a polymerization inhibitor.

In one embodiment, the functionalized polymer is present in an amount corresponding to from about 1 to about 10 weight % of the entire composition based on all components. In an alternate embodiment, the functionalized polymer is present in an amount corresponding to from about 1.5 to about 3.5 weight % of the entire composition based on all components. In one embodiment, the reactive monomer is present in an amount corresponding to from about 6 to about 20 weight %, more particularly about 7 to about 10 weight % of the entire composition based on all components. In one embodiment, the polymerization inhibitor is present in an amount corresponding to from about 0.02 to about 0.15 weight %, more particularly about 0.04 to about 0.06 weight % of the entire composition based on all components. In one embodiment, the reinforcing filler is present in amount corresponding to from about 40 to about 92 weight %, more particularly, about 60 to about 86 weight % of the entire composition based on all components. In one embodiment, the curing agent is present in an amount corresponding to from about 0.2 to about 1.0 weight %, more particularly, about 0.3 to about 0.4 weight % of the entire composition based on all components. In one embodiment, the mold release agent is present in an amount corresponding to from about 0.2 to about 0.6 weight %, more particularly, about 0.3 to about 0.4 weight % of the entire composition based on all components. In one embodiment, the colorant is present in an amount corresponding to from about 0.1 to about 1.0 weight %, more particularly, about 0.2 to about 0.4 weight % of the entire composition based on all components. In one embodiment, the flame retardant present in an amount corresponding to from about 0.5 to about 5 weight %, more particularly, about 0.8 to about 1.7 weight % of the entire composition based on all components. In one embodiment the adhesion promoter present in an amount corresponding to from about 0 to about 1.5 weight %, more particularly, about 0.7 to about 1.3 weight % of the entire composition based on all components.

Suitable fillers include, but are not limited to, alumina, zinc oxide, talc, silica (e.g. fused silica, fumed silica, colloidal silica, and the like) boron nitride, titania, titanium diboride, fly ash, calcium carbonate, carbon black, graphite, and the like.

The reinforcing fillers may be of a variety of dimensions. In one embodiment the reinforcing filler comprises particles which are essentially spherical. In another embodiment the reinforcing filler is comprised of particles essentially all of which have at least one dimension (length, width or breadth) less than or equal to 75 microns. In another embodiment the reinforcing filler is comprised of particles essentially all of which have at least one dimension (length, width or breadth) less than or equal to 50 microns. In another embodiment the reinforcing filler is comprised of particles essentially all of which have at least one dimension (length, width or breadth) less than or equal to 35 microns. In another embodiment the reinforcing filler is comprised of particles essentially all of which have at least one dimension (length, width or breadth) less than or equal to 25 microns. In another embodiment the reinforcing filler is comprised of particles having a bimodal particle size distribution. In another embodiment the reinforcing filler is comprised of particles having a trimodal or higher particle size distribution. In another embodiment the reinforcing filler is comprised of particles having a bimodal particle size distribution wherein essentially all of the particles present are spherical

A suitable silica filler is fused silica, formed for instance, by treatment of a silica with a silane coupling agent. For example, an alcohol solution of gamma-methacryloxypropyl trimethoxy silane coupling agent (Z-6030 from Dow Corning), catalyzed with a small amount of water and acetic acid, and is sprayed onto silica (FB 570 silica and SFP 30M silica in a 90:10 ratio), leaving silanol groups, followed by heating at 95° C., to condense the silanol groups. FB 570 silica and SFP 30M silica are sold by Denki Kagaku Kogyo Kabushiki Kaisha, (doing business as Denka Group) Tokyo, Japan.

Suitable curing agents include, but are not limited to, azo compounds, organic peroxides, or combinations thereof. Suitable azo compounds include, but are not limited to, azobisisobutyronitrile. Suitable organic peroxides include, but are not limited to, dicumyl peroxide, t-butyl peroxy benzoate, or combinations thereof. When the curing agent is an organic peroxide curing agent, a partial cure time ranging from about 80 to about 100 seconds, more typically about 90 seconds, is desirable. The partial cure time may be determined with a Dynamic Cure Monitor (an apparatus that measures the cure profile using a dielectric spectrometer built into a heated platen press). The partial cure time is typically increased by the presence of the polymerization inhibitor.

Suitable mold release agents include, but are not limited to, stearic acids, metal salts of stearic acids, montanic acids, esters of fatty acids, such as carnauba wax, or combinations thereof. A suitable metal salt of a stearic acid is zinc stearate. A suitable montanic acid mold release agent is a partly saponified esterified montanic acid that is a wax sold by Clariant under the trademark LICOWAX® OP.

Suitable colorants include, but are not limited to, carbon black (sold by Printex under the trade name XE2). Suitable flame retardants include, but are not limited to, melamine polyphosphate (sold by Ciba Specialty Chemicals under the trademark MELAPUR® 200), aluminum diethyl phosphinate (sold by Clariant under the trade name OP 930), mixture of melamine polyphosphate and aluminum diethylphosphinate (sold by Clariant under the trade name OP 1311), or combinations thereof. Additional suitable flame retardants include melamine pyrophosphate, antimony trioxide, antimony pentoxide, alumina trihydrate, magnesium hydroxide, and the like. Additionally suitable organic flame retardants include halogenated aromatic compounds (e.g. dibromostyrene and polymers thereof, tetrabromobisphenol A and polymers thereof), and the like.

Suitable adhesion promoters include, but are not limited to, styrene maleic anhydride, zinc acrylate (sold by Sartomer), partially acrylated bisphenol A epoxy (sold by Surface Specialties under the trademark EBECRYL® 3605), mixture of bisphenol A epoxy and diaminodiphenylmethane, or combinations thereof.

As will be understood by those skilled in the art, a wide variety of additional additives may also be included in the compositions provided by the present invention. There include, but are not limited to functionalized liquid rubber, micronized rubber, metal adhesion promoters, soldermask adhesion promoters, ion exchange additives, antioxidants, polymerization accelerators, resin hardeners and the like.

The compositions of the present invention are useful in transfer molding processes. Inone embodiment, the composition of the present invention is formed into a pellet which is advantageously employed in a transfer molding process, for example, the encapsulation of an electronic device such as a circuit. Those skilled in the art will appreciate that pellets comprising the compositions of the present invention are readily formed by conventional techniques such as compression of the composition in a mold at ambient temperature.

Typically, the transfer molding apparatus has a pot, which is a generally cylindrical cavity fitted with a generally retractable plunger. The composition of the present invention in pellet form and the pot have approximately the same diameter. The pot is kept hot, typically at the same temperature as the molding tool. After the pellet has been inserted into the pot, the plunger presses the pellet through an opening at the bottom of the pot into the hot runner system of the molding tool. Cycle time typically ranges from about 1 to about 4 minutes, and may be shorter or longer.

The pot and the molding tool typically are held at a temperature from about 130° C. to about 175° C., more typically from about 140° C. to about 175° C. Temperatures higher than about 175° C. are usually not used, as such high temperatures can melt eutectic tin-lead solder. Frequently the electronic component being encapsulated will have solder coating or soldered joints which are degraded or melted at temperatures above about 175° C.

If the pellet is small (under about 7 grams), the pellet typically can be softened within a few seconds, simply by inserting the pellet into the transfer pot. On the other hand, if the pellet is large (over about 7 grams, more typically about 8 to about 80 grams), the pellet typically is pre-heated to about 80° C. skin temperature, using a radio frequency pre-heater with an infrared pyrometer, and then inserted into the transfer pot.

A low softening temperature for the pellet during transfer molding is desirable since the composition will not flow out of the pot until the pellet has softened. However, if the softening temperature is less than about 50 to about 60° C., then the pellet may not survive transportation and storage without deformation or sintering to other pellets. On the other hand, if the softening temperature of the composition is too high, then considerable curing may occur in the pot prior to transfer molding, which is not generally desirable. Typically, the pellet cannot soften unless the reactive monomer melts or softens. As noted above, desirable molding compositions useful for encapsulation of electronic devices should soften between 50’0 C. and 110° C. This typically is achieved with the inventive compositions.

Desirable processing for transfer molding generally correlates to the spiral flow length of the composition. Spiral flow length may be measured by SEMI G11-88 recommended practice for ram follower gel time and spiral flow of thermal setting molding compounds, or by EMMI 1-66. Usually, spiral flow length is measured at about 1 MPa and about 150° C. Typically, a composition having a spiral flow length ranging from about 30 to about 50 inches is desirable. The spiral flow length of the inventive compositions typically is in that range, but can range from about 11 inches to about 61 inches, and varies with what reactive diluent is used. The spiral flow length is typically increased by the presence of the polymerization inhibitor, and is typically decreased by the presence of filler, colorant, and/or flame retardant. Additionally, the spiral flow length is typically decreased by using more of the CPAE, particularly MACPDMPE. Also, when a mix of 0.12 IV MACPDMPE and 0.30 IV MACPDMPE is used, then increasing the amount of 0.12 IV in the mix typically increases the spiral flow length. As noted above, desirable molding compositions should exhibit a desirable flow (spiral flow length) at low viscosity at 125° C. to 175° C., and this is typically achieved with the inventive compositions.

Also, desirable molding compositions should exhibit a hardness ranging from about 20 Shore D to about 60 Shore D, more particularly from about 30 Shore D to about 50 Shore D, and this is typically achieved with the inventive compositions.

Additionally, desirable molding compositions, after curing, should exhibit a flex strength ranging from about 65 MPa to about 160 MPa, more particularly from about 70 MPa to about 150 MPa, and this is typically achieved with the inventive compositions.

Although it is not intended to be bound to any theory, it is believed that capping should provide the following advantages over, for instance, polyphenylene ether (also called polyphenylene oxide), which is known in the prior art as a polymer used in molding compositions for encapsulation of electronic devices. It is believed that the capping should improve the bending strength (also called flex strength) of the composition as compared to a composition made with non-capped PPE. Also, it is believed that when the capping is analogous to the reactive monomer, for instance capping the polymer with methacrylate and employing a diluent comprising a methacrylate, then the capped polymer should have improved solubility in the reactive monomer over the non-capped PPE, which improved solubility should facilitate making a composition. Furthermore, in connection with curing (curing agents are discussed further below), it is known that phenolic hydroxyl groups inhibit free-radical cure, and thus, capping should separate cure kinetics from the loading amount of polymer in the composition. Additionally, as seen by viewing compositions of the invention under a microscope, it is believed that the capping results in a microstructure that is finer grained after curing, as compared to a composition made with non-capped PPE.

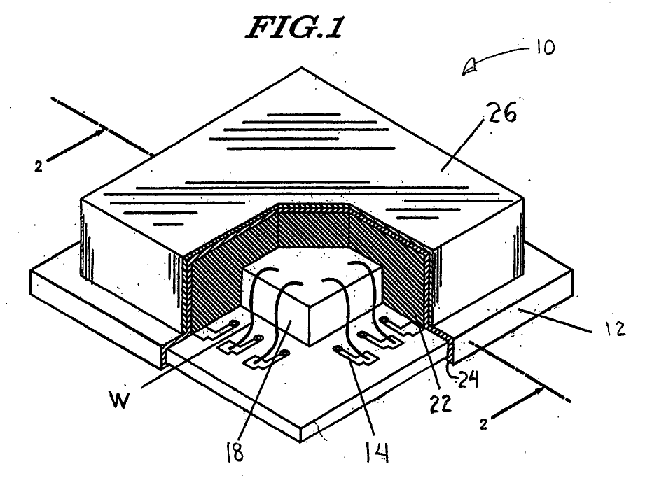

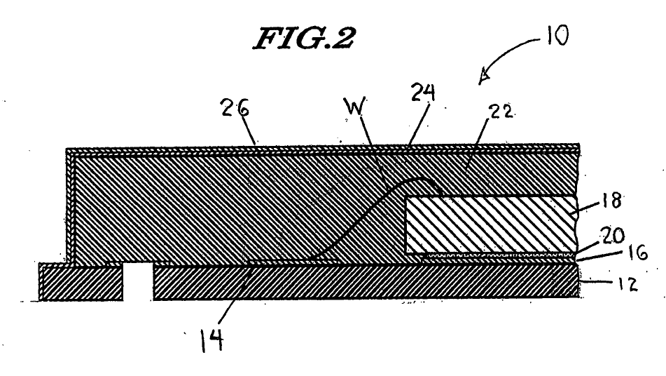

Turning now to the drawings in FIGS. 1 and 2, like reference numerals refer to like elements throughout. It is noted that the various features shown are not to scale. The following is intended to be illustrative, and it is not intended to limit the invention to encapsulation of an assembly of an integrated circuit on a printed circuit board, nor is it intended to limit the invention to the specific components of the assembly that are shown encapsulated.

Depicted in FIG. 1 is a perspective, cut-away view of an electronic assembly 10, and depicted in FIG. 2 is a cross-sectional view of the electronic assembly 10 that is taken through section 2-2 of FIG. 1. The electronic assembly 10 includes a substrate 12. The substrate 12 may be any of a number of materials commonly used in the electronics industry, including, but not limited to, polymer, glass, metal, and/or ceramic, and may be flexible or rigid. The substrate 12 typically is a printed circuit board, an epoxy circuit card, or a copper lead frame.

As is known in the art, the substrate 12 may be provided as a carrier for a metallization pattern which includes an interconnection pad 14 and a mounting area 16 (FIG. 2), on which an electronic component 18 may be mounted, for instance, by an adhesive 20 (FIG. 2). Also, as is known in the art, the electronic component 18 may be mounted by solder attach to the mounting area 16.

Representative electronic components 18, which may be encapsulated, are transistors, capacitors, relays, diodes, resistors, networks of resistors, integrated circuits, and the like. The electronic component 18 typically is connected with the wires W to the various pads 14. The wires W are typically metal wires of gold or aluminum.

The electronic component 18 and the wires W are shown encapsulated with the polymeric composition 22 in accordance with the present invention. The thickness of the polymeric composition 22 generally ranges from about 0.1 to about 3.5 mm, more typically, about 0.5 to about 3.0 mm.

Applying the polymeric composition 22 is typically achieved by transfer molding. The assembly 10 of the substrate 12 with the electronic component 18 is placed in a transfer molding machine (not shown), which has a mold (not shown). The polymeric composition 22 is optionally preheated and inserted into a pot, and then forced from a pot into the hot mold cavity. The polymeric composition 22 molds totally around the electronic component 18 and the associated wires W, and also around portions of the pads 14, the mounting areas 16, and the substrate 12. Upon solidification, the molded part is ejected from the mold.

Techniques and equipment for performing transfer molding are well known to those skilled in the art, and transfer molding of the polymeric composition 22 may be performed in accordance with the embodiment described above.

### EXAMPLES

The tack-free compositions of the present invention comprising a capped polyarylene ether (CPAE), a solid reactive monomer having a melting or softening point above room temperature, an initiator, and a reinforcing filler were prepared and evaluated as described herein.

### Examples 1-10

### Preparation of Unfilled Compositions

The capped polyarylene ether (CPAE) employed was typically a methacrylate-capped poly(2,6-dimethyl phenylene ether) (MACPDMPE) having an IV of about 0.12 or about 0.30 depending on the sample employed. In some instances of a 50%/50% mixture of 0.12 IV and 0.30 IV methacrylate-capped poly(2,6-dimethyl phenylene ether)s was employed.

A variety of reactive monomers were evaluated in the tack-free compositions of the present invention. In Examples 1-10 cyclohexane dimethanol diacrylate (sold by Sartomer under the trademark SARTOMER® CD 406) was employed, optionally together with one or more other reactive monomers. For example, mixtures of cyclohexane dimethanol diacrylate (CDD) and ethoxylated(2) bisphenol A dimethacrylate (sold by EBAM under the trade name SR-348, abbreviated herein as E2BPA) or 1,6-hexanediol diacrylate (sold by EBAM under the trade name SR-248, abbreviated here as 1,6-HDD) were employed.

Typically a polymerization inhibitor, t-butyl catechol (abbreviated herein as TBC), was included in the composition at a concentration of approximately 1000 ppm of to prevent premature polymerization of the composition.

Compositions were conveniently prepared by blending the components under vigorous stirring in a container for about 15 minutes at about 170° C. on a hot plate until a clear liquid formed. The hot liquid was quenched by pouring the contents of the container into a shallow aluminum pan at room temperature. Within minutes, crystalline spherulites were observed to form and to grow in the quenched composition. The quenched composition was a hard solid which was shown to be “friable”. Friability was determined by striking a portion of the solid composition with a hammer and observing the formation of a powder having discrete particles.

The ingredients of the compositions of Examples 1-10 are summarized in Table 1 below, where the amounts have been reported in parts by weight % of the total composition.

TABLE 1

| | | | Reactive | | | |
|---|---|---|---|---|---|---|
| | | | Monomer | | | |
| | | | CDD | | 1,6- | TBC |
| | MACPDMPE | | (parts | E2BPA | HDD | (parts |
| | (parts by | | by weight | (parts by | (parts by | by |
| o. | weight %) | IV | %) | weight %) | weight %) | weight %) |
| 1 | 20 | 50% | 80 | 0 | 0 | 0.1 |
| | | 0.12 | | | | |
| | | 50% | | | | |
| | | 0.30 | | | | |
| 2 | 20 | 50% | 60 | 0 | 20 | 0.1 |
| | | 0.12 | | | | |
| | | 50% | | | | |
| | | 0.30 | | | | |
| 3 | 20 | 0.12 | 80 | 0 | 0 | 0.1 |
| 4 | 20 | 0.12 | 60 | 0 | 20 | 0.1 |
| 5 | 15 | 0.30 | 85 | 0 | 0 | 0.1 |
| 6 | 20 | 0.30 | 80 | 0 | 0 | 0.1 |
| 7 | 25 | 0.30 | 75 | 0 | 0 | 0.1 |
| 8 | 20 | 0.30 | 60 | 20 | 0 | 0.1 |
| 9 | 20 | 0.30 | 40 | 40 | 0 | 0.1 |
| 0 | 20 | 0.30 | 60 | 0 | 20 | 0.1 |

### Example 11

### And General Method for Preparation of Filled Compositions

The composition of Example 3 was combined with fused silica (a mixture of the silicas FB 570 and SFP 30M treated with gamma-methacryloxy propyl trimethoxy silane), dicumyl peroxide as a curing agent, CERIDUST® mold release agent (CLARIANT), a colorant mixture of green and red colorants, SANDOPLAST® Red G and SANDOPLAST® Green GSB (CLARIANT), and aluminum diethylphosphinate (OP 930, CLARIANT) as a flame retardant, in a Brabender mixing bowl fitted with roller mixing blades operated at about 80 rpm. The bowl temperature was about 80° C. and mixing time was about 5 minutes.

The ingredients of the resulting filled composition are summarized in Table 2 below.

TABLE 2

| INGREDIENT | GRAMS | WEIGHT % |
|---|---|---|
| MACPDMPE | 13.28 | 2.45 |
| CDD | 53.14 | 9.8 |
| TBC | 0.27 | 0.05 |
| fused silica | 462.24 | 85.3 |
| dicumyl peroxide | 1.62 | 0.3 |
| mold release agent | 2.16 | 0.4 |
| red/green colorant blend | 1.08 | 0.2 |
| ADEP | 8.1 | 1.5 |
| TOTAL | 541.89 | 100 |

General Procedure for Comparative Examples 1 and 2 and Examples 12-24.

The CPAE employed was a methacrylate capped poly(2,6-dimethyl phenylene ether) having an IV of 0.30 or 0,12. The reactive monomer was selected from among ethoxylated(2) bisphenol A dimethacrylate (abbreviated here as “E2BPA”); bisphenol A dimethacrylate (abbreviated here as “BPA”); 1,5-dimethacryloyl naphthalene (abbreviated here as “1,5-NP”); bis[[4-[(vinyloxy)methyl]cyclohexyl]methyl]terephthalate (sold by Morflex Inc. under the name VECTOMER® 4051, abbreviated here as “BVM”); tetramethyl bisphenol A dimethacrylate (abbreviated here as “TMBPA”); tetramethyl biphenol dimethacrylate (abbreviated here as “TMBiPh”); and 4-biphenyl methacrylate (abbreviated here as “4-BiPh”) and mixtures thereof. Each of the compositions of Comparative Examples 1-2 and Examples 12-24 comprised t-butyl catechol as a polymerization inhibitor. With the exception of the compositions of Examples 15 and 16, an adhesion promoter, styrene maleic anhydride (SMA) was employed. The SMA was included to enhance adhesion of the final composition to a substrate.

The compositions of Comparative Examples 1 and 2 and Examples 12-24 were prepared as described below. Comparative Examples 1 and 2 are designated as “comparative examples” because these compositions do not comprise a reactive monomer having a melting or softening temperature above room temperature. The reactive monomer E2BPA is a liquid at room temperature. The methacrylate-capped poly(2,6-dimethyl phenylene ether, reactive monomer, optional adhesion promoter (SMA), and t-butyl catechol ingredients were mixed in a 200 milliliter beaker, which was immersed in a stirred, 4 liter oil bath at about 170° C. An overhead stirrer was used to agitate the contents of the beaker for about 15 minutes, at the end of which time, the contents of the beaker had been transformed into a transparent liquid. The beaker was removed from the oil bath, and allowed to cool on the bench, while being monitored with a glass thermometer until the temperature cooled to about 100° C., at which point the colorant and mold release agent (stearic acid) were added with manual stirring. When the temperature had cooled to about 80° C., the t-butyl peroxy benzoate curing agent was added with manual stirring.

Next, the hot liquid was quenched by pouring the contents from the beaker into a shallow aluminum pan at room temperature. Within minutes, crystalline spherulites were seen to form and to grow in the quenched composition. Approximately 80 grams of each composition were produced for each of Comparative Examples 1-2 and Examples 12-24. Approximately 71.2 grams of each composition was crushed into small pieces and compounded with a filler and a flame retardant as follows.

The filler, fused silica (a mixture of FB 570 and SFP 30M treated with gamma-methacryloxy propyl trimethoxy silane, as described above), was mixed with the flame retardant OP 1311 (a mixture of melamine polyphosphate and aluminum diethylphosphinate, CLARIANT) in a Henschel mixer at room temperature. Note, however, that the compositions of Examples 15 and 16 contained no flame retardant. Next, the filler mixture was split into two approximately equal portions.

The first potion of the filler mixture was poured into a Brabender mixing bowl fitted with roller mixing blades operated at 80 rpm. The bowl temperature was about 80° C. Next, approximately 71.2 grams of the crushed mixture of the methacrylate-capped poly(2,6-dimethyl phenylene ether, reactive monomer, optional adhesion promoter (SMA), and t-butyl catechol ingredients was charged into the Brabender mixer, followed immediately by the second portion of the filler mixture. The total mixing time was about 5 minutes. The resulting filled composition had a mass of about 540 grams.

The ingredients used in Comparative Examples 1-2 and Examples 12-24 are summarized in Table 3.

TABLE 3
(Comparative Examples 1-2 and Examples 12-24)

| INGREDIENT | WEIGHT % |
|---|---|
| MACPDMPE* | 1.71 |
| Reactive Monomer | 9.67 |
| TBC | 0.06 |
| SMA** | 0.86 |
| colorant | 0.10 |
| stearic acid | 0.40 |
| TBPB*** | 0.38 |
| fused silica | 85.6 |
| Flame retardant mixture** | 1.25 |
| TOTAL | 100 |

*Example 16, MACPDMPE with an IV of 0.12 was employed.
**Examples 15 and 16, there was no SMA and no flame retardant.
***Comparative Example 2, the amount of TBPB was greater than 0.38%.

The weight % amounts of each of the various reactive monomers, based on the total amount of reactive monomer, for the compositions of Comparative Examples 1-2 and Examples 12-24 are summarized in Table 4 below.

TABLE 4

| | Reactive Monomer(weight % amount) | | | | | | |
|---|---|---|---|---|---|---|---|
| | | | 1,5- | | | | 4- |
| o. | E2BPA | PA | NP | [symbol] VM | TMBPA | TMBiPh | BiPh |
| E-1 | 100 | | 0 | 0 | 0 | 0 | 0 |
| E-2 | 100 | | 0 | 0 | 0 | 0 | 0 |
| 12 | 80 | | 0 | 0 | 0 | 0 | 20 |
| 13 | 60 | | 0 | 0 | 0 | 0 | 40 |
| 14 | 70 | | 0 | 0 | 0 | 0 | 30 |
| 15 | 60 | | 0 | 0 | 0 | 0 | 40 |
| 16 | 60 | | 0 | 0 | 0 | 0 | 40 |
| 17 | 40 | 0 | 0 | 0 | 0 | 0 | 30 |
| 18 | 40 | | 30 | 0 | 0 | 0 | 30 |
| 19 | 80 | | 0 | 20 | 0 | 0 | 0 |
| 20 | 80 | 0 | 0 | 0 | 0 | 0 | 0 |
| 21 | 80 | | 20 | 0 | 0 | 0 | 0 |
| 22 | 80 | | 0 | 0 | 20 | 0 | 0 |
| 23 | 80 | | 0 | 0 | 0 | 20 | 0 |
| 24 | 50 | | 25 | 0 | 0 | 0 | 25 |

Various properties of the 1compositions of Comparative Examples 1-2 and Examples 12-24 were measured and data are summarized in Table 5 below.

TABLE 5

| | Properties | | |
|---|---|---|---|
| | Spiral | | |
| | Flow | Hardness | Flex Strength |
| No. | (inches) | (Shore D) | (MPa) |
| E-1 | 31 | 16 | 119 |
| E-2 | 36 | not | 121 |
| | | measured | |
| 2 | 36 | 21 | 114 |
| 3 | 50 | 43 | 75.4 |
| 4 | 47 | 35 | 92 |
| 5 | 80 | not | 83 |
| | | measured | |
| 6 | 95 | not | 110 |
| | | measured | |
| 7 | 40.5 | 25 | 64 |
| 8 | 17 | 32 | 73 |
| | | | (retested at 85) |
| 9 | 31 | 17 | 123 |
| 0 | not | not | not measured |
| | measured | measured | |
| 1 | not | not | not measured |
| | measured | measured | |
| 2 | not | not | not measured |
| | measured | measured | |
| 3 | not | not | not measured |
| | measured | measured | |
| 4 | 39 | 38 | 81 |

Examples 25-30 demonstrate the compositions of the present invention in which all of the reactive monomers used are solid materials. The compositions were prepared as described for Comparative Examples 1-2 and Examples 12-24

### Example 25

| | | Weight |
|---|---|---|
| Component | Chemical | (g) |
| Filler | Treated Silica | 449.25 |
| Monomer1 | BPA dimethacrylate | 35.53 |
| Monomer2 | Biphenyl methacrylate (BPM) | 15.23 |
| Inhibitor | 4-t-butyl catechol | 0.33 |
| Initiator | tert-Butyl perbenzoate (TBPB) | 1.99 |
| PPO | 0.30 iv MACPDMPE | 8.98 |
| Adhesion Promoter | SMA | 4.51 |
| Dye | Keystone Green | 0.52 |
| Mold Release | Stearic acid | 2.10 |
| Flame Retardant | OP1311 | 6.56 |

### Example 26

| | | Weight |
|---|---|---|
| Component | Chemical | (g) |
| Filler | Treated Silica | 495.64 |
| Monomer1 | Bisphenol Z Dimethacrylate | 39.28 |
| Monomer2 | Biphenyl methacrylate (BPM) | 16.83 |
| Inhibitor | 4-t-butyl catechol | 0.42 |
| Initiator | tert-Butyl perbenzoate (TBPB) | 2.20 |
| PPO | 0.12 iv bifunctional MACPDMPE | 9.90 |
| Adhesion Promoter | SMA | 4.97 |
| Pigment | Black Pearls | 1.74 |
| Mold Release | Stearic acid | 1.74 |
| Flame Retardant | OP1311 | 7.27 |

### Example 27

| | | Weight |
|---|---|---|
| Component | Chemical | (g) |
| Filler | Treated Silica | 496.46 |
| Monomer1 | Benzophenone dimethacrylate | 39.29 |
| Monomer2 | Benzophenone methacrylate | 16.84 |
| Inhibitor | 4-t-butyl catechol | 0.63 |
| Initiator | tert-Butyl perbenzoate (TBPB) | 1.16 |
| PPO | 0.12 iv bifunctional MACPDMPE | 9.91 |
| Adhesion Promoter | SMA | 4.97 |
| Pigment | Black Pearls | 1.74 |
| Mold Release | Licowax S | 1.74 |
| Flame Retardant | OP1311 | 7.27 |

### Example 28

| | | Weight |
|---|---|---|
| Component | Chemical | (g) |
| Filler | Treated Silica | 496.46 |
| Monomer1 | Benzophenone dimethacrylate | 39.29 |
| Monomer2 | Benzophenone methacrylate | 16.84 |
| Inhibitor | 4-t-butyl catechol | 0.63 |
| Initiator | tert-Butyl perbenzoate (TBPB) | 1.16 |
| PPO | 0.12 iv bifunctional MACPDMPE | 9.90 |
| Adhesion Promoter | SMA | 4.97 |
| Pigment | Black Pearls | 1.74 |
| Mold Release | Carnauba Wax | 1.74 |
| Flame Retardant | OP1311 | 7.27 |

### Example 29

| | | Weight |
|---|---|---|
| Component | Chemical | (g) |
| Filler | Treated Silica | 495.67 |
| Monomer1 | 3,3′-(Ethylenedioxy)diphenol | 39.27 |
| | Dimethacrylate | |
| Monomer2 | Biphenyl methacrylate (BPM) | 16.83 |
| Inhibitor | 4-t-butyl catechol | 0.41 |
| Initiator | tert-Butyl perbenzoate (TBPB) | 2.21 |
| PPO | 0.12 iv bifunctional MACPDMPE | 9.90 |
| Adhesion Promoter | SMA | 4.97 |
| Pigment | Black Pearls | 1.74 |
| Mold Release | Carnauba Wax | 1.74 |
| Flame Retardant | OP1311 | 7.27 |

### Example 30

This example demonstrates the use of a glassy solid methacrylate in combination with a crystalline material. This formulation was prepared by mixing the following ingredients as described for Comparative Examples 1-2 and Examples 12-24.

| | | Weigt |
|---|---|---|
| Component | Chemical | (g) |
| Filler | Treated Silica | 495.38 |
| Monomer1 | Partially Methacrylated Novolac Resin | 39.27 |
| Monomer2 | Biphenyl methacrylate (BPM) | 16.83 |
| Inhibitor | 4-t-butyl catechol | 0.42 |
| Initiator | tert-Butyl perbenzoate (TBPB) | 2.21 |
| PPO | 0.12 iv bifunctional MACPDMPE | 9.90 |
| Adhesion Promoter | SMA | 4.97 |
| Pigment | Black Pearls | 1.74 |
| Mold Release | Carnauba Wax | 3.48 |
| Flame Retardant | OP1311 | 5.80 |

Examples 25-30 were then pressed into pellets and their hardness was measured. They were also transfer molded at 150° C. and their spiral flow values were measured. The results are recorded in Table 6 below.

TABLE 6
Hardness and Flow Values for Examples 25-30

| | Pellet Hardness | Spiral Flow |
|---|---|---|
| Example Number | (Shore D) | (inches) |
| 25 | 52.7 | 45.2 |
| 26 | 68.1 | 37.0 |
| 27 | 66.2 | 45.2 |
| 28 | 70.9 | 41.3 |
| 29 | 62.9 | 48.8 |
| 30 | 74.8 | 24.0 |

Although the present invention has been shown and described in considerable detail with respect to only a few exemplary embodiments, it should be understood by those skilled in the art that it is not intended to limit the invention to the disclosed embodiments since various modifications, omissions and additions may be made to the disclosed embodiments without materially departing from the novel teachings and advantages of the invention, particularly in light of the foregoing teachings. Accordingly, it is intended to cover all such modifications, omissions, additions and equivalents as may be included within the spirit and scope of the invention as defined by the following claims.

What is claimed is:

1. A composition comprising:
(a) at least one functionalized polymer having a glass transition temperature greater than about 24° C.;
(b) at least one reactive monomer, said reactive monomer having a melting point or softening point greater than about 24° C.;
(c) at least one reinforcing filler; and
(d) at least one initiator;
said composition being tack-free at room temperature.

2. The composition according to claim 1, wherein said functionalized polymer is a functionalized polyarylene ether.

3. The composition according to claim 2, wherein said functionalized polyarylene ether comprises methacryloyl groups.

4. The composition according to claim 1, wherein said functionalized polymer has an intrinsic viscosity in chcloroform less than about 0.3 g/dl.

5. The composition according to claim 1, wherein said reactive monomer comprises at least one moiety selected from the group consisting of alkeneyl groups, allyl groups, vinyl groups, acrylate groups, methacrylate groups, vinyl ether groups, vinyl ketone groups, and cinnamyl groups.

6. The composition according to claim 1, wherein said reactive monomer comprises methacrylate groups.

7. The composition according to claim 1, wherein said reactive monomer has a melting point in a range between about 24° C. and about 175° C.

8. The composition according to claim 1, wherein said reactive monomer has a softening point in a range between about 24° C. and about 175° C.

9. The composition according to claim 1, wherein said initiator is a free radical initiator.

10. The composition according to claim 9, wherein said initiator comprises a peroxide.

11. The composition according to claim 10, wherein said peroxide is tert-butyl peroxybenzoate.

12. The composition according to claim 1, wherein said reinforcing filler is selected from the group consisting of silica, fused silica, fumed silica, colloidal silica, alumina, boron nitride, titania, titanium diboride, talc, fly ash, calcium carbonate, carbon black, graphite.

13. The composition according to claim 1, wherein said reinforcing filler is a silica optionally modified by treatment with at least one of a silazane, a silane, or a combination thereof.

14. The composition according to claim 1, wherein said reinforcing filler comprises essentially spherical particles.

15. A cured composition comprising structural units derived from:
(a) at least one functionalized polymer having a glass transition temperature greater than about 24° C.;
(b) at least one reactive monomer, said reactive monomer having a melting point or softening point greater than about 24° C.;
(c) at least one reinforcing filler; and
(d) at least one initiator;
said composition being tack-free at room temperature prior to being cured.

16. The cured composition according to claim 15, wherein said functionalized polymer is a functionalized polyarylene ether.

17. The cured composition according to claim 16, wherein said functionalized polyarylene ether comprises methacryloyl groups.

18. The cured composition according to claim 1, wherein said functionalized polymer has an intrinsic viscosity in chcloroform less than about 0.3 g/dl.

19. A composition comprising:
(a) at least one functionalized polyarylene ether having a glass transition temperature greater than about 24° C., said polyarylene ether comprising methacryloyl groups;
(b) at least one reactive monomer, said reactive monomer having a melting point or softening point greater than about 24° C., said reactive monomer comprises at least one moiety selected from the group consisting of alkeneyl groups, allyl groups, vinyl groups, acrylate groups, methacrylate groups, vinyl ether groups, vinyl ketone groups, epoxide groups, and glycidyl ether groups;
(c) at least one reinforcing filler; and
(d) at least one free radical initiator;
said composition being tack-free at room temperature.

20. The composition according to claim 19 wherein, said reactive monomer is a bisphenol diacrylate.

21. An electronic circuit comprising at least one active or passive component, said electronic circuit being encapsulated by a composition comprising structural units derived from:
(a) at least one functionalized polymer having a glass transition temperature greater than about 24° C.;
(b) at least one reactive monomer, said reactive monomer having a melting point or softening point greater than about 24° C.;
(c) at least one reinforcing filler; and
(d) at least one initiator;
said composition being tack-free at room temperature.
